(19) United States
(12) Patent Application Publication
(10) Pub. No.: US 2015/0331593 A1
(43) Pub. Date: Nov. 19, 2015

(54) DISPLAY DEVICE AND METHOD FOR CONTROLLING THE SAME

(71) Applicant: LG ELECTRONICS INC., Seoul (KR)

(72) Inventors: Doyoung LEE, Seoul (KR); Yongsin KIM, Seoul (KR)

(21) Appl. No.: 14/448,456

(22) Filed: Jul. 31, 2014

(30) Foreign Application Priority Data
May 19, 2014 (KR) 10-2014-0059482

(51) Int. Cl. G06F 3/0484; G06F 1/16

(52) U.S. Cl. CPC G06F 3/04845; G06F 1/1641; G06F 1/1652

(57) ABSTRACT

A display device providing an expanded display is disclosed. A display device includes a display unit configured to include a first display area and a second display area, a folding sensing unit configured to sense a folded state or an unfolded state of the display unit and a processor configured to control the display unit and the folding sensing unit. And, the processor is configured to display an application allocated to the first display area in the first and the second display area based on a time interval between a time of switching a display mode of the first display area and a time of unfolding the display device.

This application claims the benefit of the Korean Patent Application No. 10-2014-0059482, filed on May 19, 2014, which is hereby incorporated by reference as if fully set forth herein.

### BACKGROUND OF THE INVENTION

1. Field of the Invention

The present specification relates to a display device and a method of controlling therefor.

2. Discussion of the Related Art

A portable display device (e.g., a cellular phone, a PDA, a tablet PC and the like) is widely disseminating. And, in order to provide a wider display, a display of the portable display device is becoming larger and larger. Yet, there exists a problem that the enlargement of the portable display device decreases portability of the display device.

In order to solve the aforementioned problem, a flexible display has been suggested as an alternative. For instance, two or more display units are folded in a foldable display. Hence, the foldable display provides a big display when the foldable display is unfolded and can provide high portability when the foldable display is folded.

Yet, a study on a legacy flexible display is concentrated on a driving part of the flexible display and a material of the flexible display only. Hence, it is necessary to perform a concrete study on a method of increasing user convenience in response to a status switching of the flexible display (e.g., switching from a folded status to an unfolded status).

### SUMMARY OF THE INVENTION

Accordingly, the present specification is directed to an apparatus and method thereof that substantially obviate one or more problems due to limitations and disadvantages of the related art. An object of the present specification is to provide a method of efficiently switching a display mode of a display device in accordance with a status switching of the display device and an apparatus therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a display device includes a display unit comprising at least a first display area and a second display area, the second display area connected with the first display area, a folding sensing unit configured to sense a folded state or an unfolded state between the first display area and the second display area and a processor configured to control the display unit and the folding sensing unit, the processor further configured to allocate an application to the first display area, if the display unit is switched to the unfolded state from the folded state, to generate a first event, the processor, if a display mode of the first display area is switched to a landscape mode from a portrait mode or is switched to the portrait mode from landscape mode, to generate a second event, if a time interval between the first event and the second event is shorter than a predetermined time threshold, to display the application in the first display area and the second display area in a manner of expanding a display of the application, and if the time interval is longer than the predetermined time threshold, to display the application in the first display area in a switched display mode.

If the display mode of the first display area is switched to the landscape mode from the portrait mode and the time interval is shorter than the time threshold, the processor is further configured to display the application in the second display area in an unfolding-landscape mode in a manner of expanding the display of the application in the second display area, the unfolding-landscape mode allocates the application to the first display area and the second display area and the display mode of each of the first and the second display area corresponds to the landscape mode.

If the display mode of the first display area is switched to the portrait mode from the landscape mode and the time interval is shorter than the time threshold, the processor is further configured to display the application in the second display area in an unfolding-landscape mode in a manner of expanding the display of the application in the second display area, the unfolding-portrait mode allocates the application to the first display area and the second display area and the display mode of each of the first and the second display area corresponds to the portrait mode.

Meanwhile, when the display unit is in the folded state, the first display area and the second display area are positioned at an external surface of the display device.

Meanwhile, when the display unit is in the folded state, the second display area is positioned at an internal surface of the display device and the first display area may correspond to a transparent display area.

Meanwhile, the processor is further configured to switch at least one display mode of the first display area and the second display area to the landscape mode from the portrait mode or to the portrait mode from the landscape mode based on an orientation of the display device.

If the display mode of the first display area is switched to the landscape mode from the portrait mode, the processor is further configured to generate the second event and if the second event is generated after a time of generating the first event, the time interval between the first event and the second event is shorter than the time threshold and the first display area is positioned at the top of the second display area, the processor is further configured to display the application in the first display area and the second display area in a manner of expanding a display of the application.

The processor is further configured to display the application in the first display area in the landscape mode in response to the second event and display the application displayed in the landscape mode in the second display area in a manner of gradually expanding the display of the application displayed in the landscape mode.

Meanwhile, if the time interval is longer than the time threshold, the processor is further configured to provide a user interface triggering the application to be displayed in the first display area and the second display area in a manner of expanding the display of the application.

Meanwhile, if the first event is generated, the processor is further configured to activate a display of the second display area.

If the first event is generated, the processor is further configured to allocate the application or a predetermined application to the second display area.

Meanwhile, the display unit may include at least one selected from the group consisting of a flexible display, a foldable display, an extendible display, a touchable display and a rollable display.

Meanwhile, the folding sensing unit is further configured to sense the folded state or the unfolded state of the display unit by measuring an angle between the first display area and the second display area.

Meanwhile, the folding sensing unit is further configured to sense the folded state or the unfolded state of the display unit by comparing an orientation of the first display area with an orientation of the second display area.

To further achieve these objects and other advantages and in accordance with the purpose of the invention, as embodied and broadly described herein, according to a different embodiment, a display device includes a display unit comprising a first display area, a second display area connected with a right side of the first display area and a third display area connected with a left side of the first display area, a folding sensing unit configured to sense a folded state or an unfolded state between the first display area and the second display area and between the first display area and the third display area and a processor configured to control the display unit and the folding sensing unit, wherein the processor is further configured to allocate an application to the first display area, if the second display area is switched to the unfolded state from the folded state, to generate a first event, if the third display area is switched to the unfolded state from the folded state, to generate a second event, if a display mode of the first display area is switched to a landscape mode from a portrait mode or is switched to the portrait mode from the landscape mode, to generate a third event, if a first time interval between the first event and the third event is shorter than a first time threshold, to display the application in the first display area and the second display area in a manner of expanding a display of the application, if the first time interval is longer than the first time threshold, to display the application in the first display area in a switched display mode.

If a second time interval between the second event and the third event is shorter than the first time threshold, the processor is further configured to display the application in the first display area and the third display area in a manner of expanding the display of the application and if the second time interval is longer than the first time threshold, the processor is further configured to display the application in the first display area in the switched display mode.

If the first event, the second event and the third event are generated within a predetermined second time threshold, the processor is further configured to display the application in the first display area, the second display area and the third display area in a manner of expanding the display of the application.

If the first event and the second event are generated while the application is displayed in the first display area in the portrait mode and a third time interval between the first event and the second event is shorter than a predetermined third time threshold, the processor is further configured to display the application in the second display area and the third display area in the landscape mode in a manner of expanding the display of the application.

If the first event and the second event are generated while the application is displayed in the first display area in the landscape mode and a third time interval between the first event and the second event is shorter than a predetermined third time threshold, the processor is further configured to display the application in the second display area and the third display area in the portrait mode in a manner of expanding the display of the application.

To achieve these objects and other advantages and in accordance with the purpose of the invention, as embodied and broadly described herein, according to one embodiment, a method of controlling a display device comprising a display unit comprising at least a first display area and a second display area comprises the steps of allocating an application to the first display area, sensing a folded state or an unfolded state between the first display area and the second display area, if the display unit is switched to the unfolded state from the folded state, generating a first event, if a display mode of the first display area is switched to a landscape mode from a portrait mode or is switched to the portrait mode from the landscape mode, generating a second event, if a time interval between the first event and the second event is shorter than a predetermined time threshold, displaying the application in the first display area and the second display area in a manner of expanding a display of the application and if the time interval is longer than the time threshold, displaying the application in the first display area in a switched display mode.

In another aspect of the present specification,

According to the aforementioned various embodiments, a display device and a method of controlling therefor can provide convenience to a user in a manner of providing an intuitive user interface to the user.

And, a display device and a method of controlling therefor according to the present specification can provide a better user experience to a user in a manner of switching a display mode of the display device in accordance with a display configuration.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a switching of a display mode of a display device;

FIG. 2 is a diagram for a configuration of a display device according to one embodiment of the present specification;

FIG. 3 is a diagram for examples of a display device;

FIG. 4a is a diagram for a folding-portrait display mode;

FIG. 4b is a diagram for a folding-landscape display mode;

FIG. 5a is a diagram showing that a first display area and a second display area display applications different from each other, respectively;

FIG. 5b is a diagram for a unfolding-landscape display mode;

FIG. 5c is a diagram for a unfolding-portrait display mode;

FIG. 6a is diagram for a switching of a display mode of a display device according to one embodiment of the present specification;

FIG. 6b is diagram for a switching of a display mode of a display device according to a different embodiment of the present specification;

FIG. 6c is diagram for a switching of a display mode of a display device according to one embodiment of the present specification;

FIG. 7a is a diagram for a folding direction of a display device according to one embodiment of the present specification;

FIG. 7b is a diagram for a folding direction of a display device according to a different embodiment of the present specification;

FIG. 8 is a diagram for expansion of a display according to a switching of a display mode;

FIG. 9 is a diagram for a display device including three display areas;

FIG. 10a is a diagram for expansion of a display according to one embodiment of the present specification;

FIG. 10b is a diagram for expansion of a display according to a different embodiment of the present specification;

FIG. 11 is a flowchart for a controlling method of a display device according to one embodiment of the present specification.

### DETAILED DESCRIPTION OF THE INVENTION

Reference will now be made in detail to the preferred embodiments of the present specification, examples of which are illustrated in the accompanying drawings. While the embodiments have been concretely described with reference to the attached diagrams and the contents written on the diagrams, a scope of claims may be non-restricted or non-limited to the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

And, structural or functional explanations, which are specified for embodiments according to a concept of the present disclosure, are described to explain embodiments according to the concept of the present specification only. Hence, the embodiments according to the concept of the present specification can be implemented in various forms rather than construed as the embodiments explained in the present specification only.

Since the embodiments according to the concept of the present specification can have various modifications and forms, the present specification is explained in detail in a manner of showing examples of specific embodiments in drawings. Yet, the embodiments according to the concept of the present specification may be non-limited to the specified disclosure form. Instead, the embodiments according to the concept of the present specification needs to be construed as the embodiments including all changes, equivalents or substitutes included in an idea and a technological scope of the present specification.

Moreover, a terminology, each of which includes such an ordinal number as 1^{st}, 2^{nd} and the like, may be used to describe various components. In doing so, the various components should be non-limited by the corresponding terminologies, respectively. The terminologies are only used for the purpose of discriminating one component from other components. For instance, a 1^{st} component may be named a 2^{nd} component while coming within the scope of the appended claims and their equivalents. Similarly, the 2^{nd} component may be named the 1^{st} component.

In the present application, such a terminology as ‘comprise’, ‘include’ and the like should be construed not as necessarily excluding various components or steps written in the present specification but as including the components or steps in part or further including additional components or steps. And, such a terminology as ‘unit’ written in the present specification indicates a unit processing at least one function or an operation and can be implemented by hardware, software or a combination thereof.

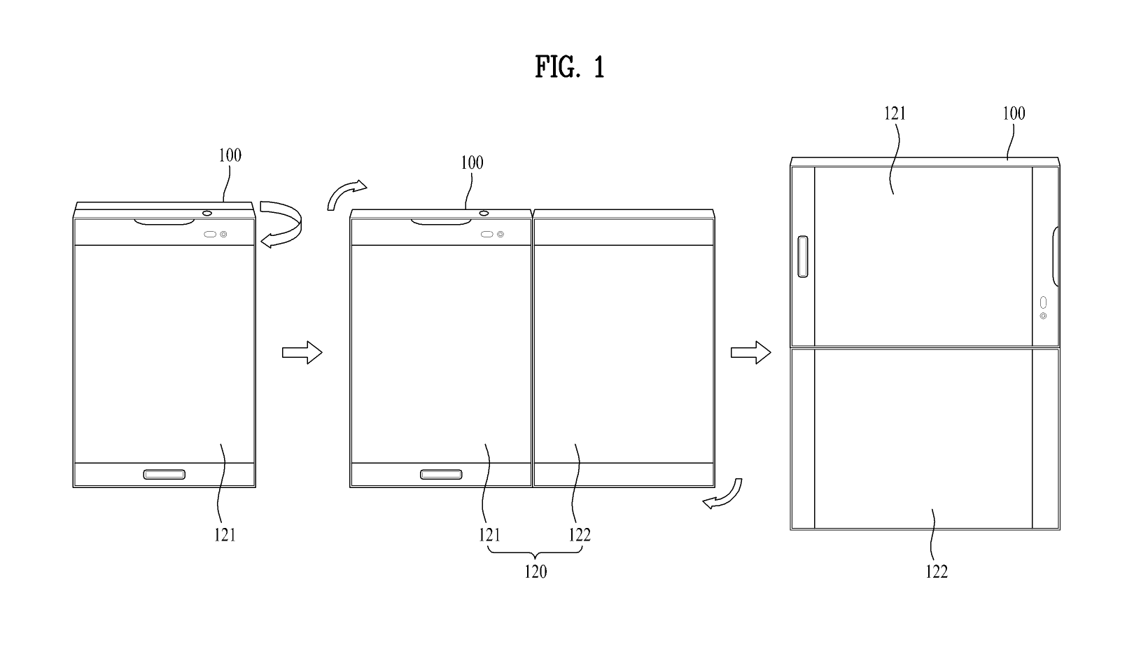

FIG. 1 is a diagram for a switching of a display mode of a display device.

A display device 100 shown in FIG. 1 includes a display unit 121 consisting of a first display area 121 and a second display area 122. As depicted in FIG. 1, the display device 100 rotates after the display device 100 is unfolded. In this case, intention of a user using the display device 100 is to see an application allocated to the first display area 121 in the first display area 121 and the second display area 122 in a manner of expanding a display of the application or to see all applications allocated to the first display area 121 and the second display area, respectively. Hence, it is necessary to have a method of controlling the intuitive display device 100 capable of reflecting the aforementioned intention of the user and providing convenience to the user.

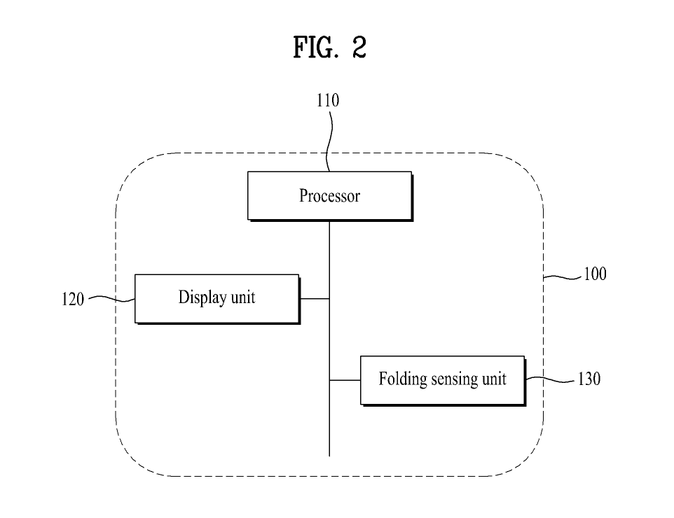

FIG. 2 is a diagram for a configuration of a display device according to one embodiment of the present specification.

As depicted in FIG. 2, the display device 100 includes a display unit 120, a folding sensor unit 130 and a processor 110 configured to control the display unit 120 and the folding sensing unit 130.

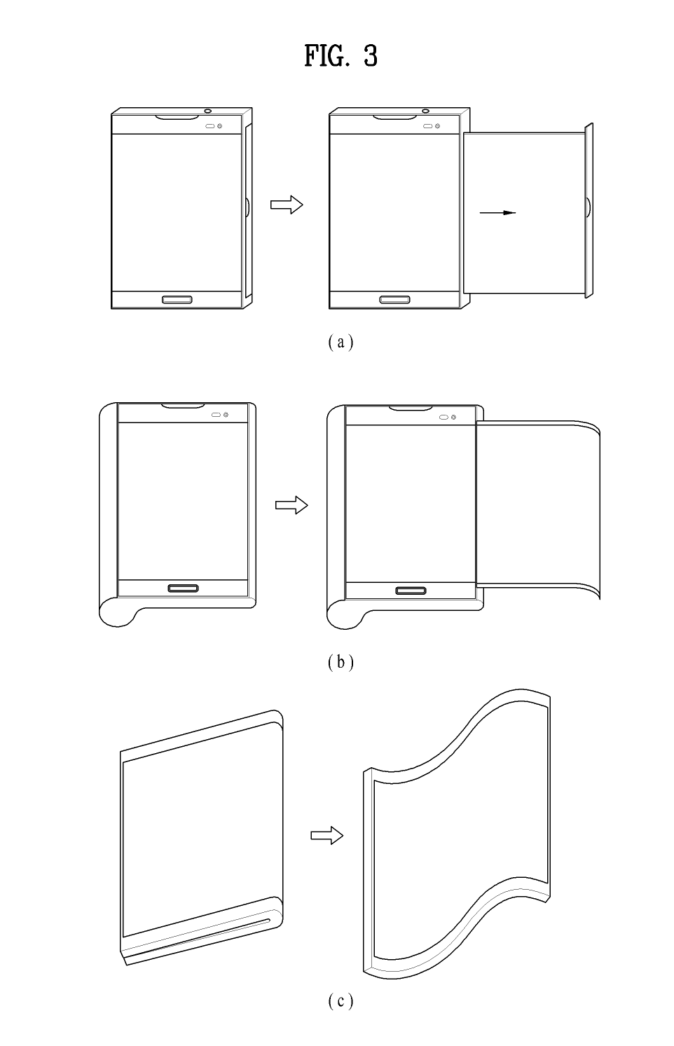

The display unit 120 includes a first display area and a second display area. In particular, the display unit includes two or more display areas. The display unit 120 may include a touch display. The display unit 120 can include a folded state or an unfolded state. The folded state can include a state that the two or more display areas of the display unit 120 are folded with each other or a state that the two or more display areas of the display unit 120 are not expanded. The unfolded state can include a state that the two or more display areas of the display unit 120 are unfolded or a state that the two or more display areas of the display unit 120 are expanded. As explained later with reference to FIG. 3, the display unit 120 can include various form factors other than the foldable display shown in FIG. 1.

Also, the folding sensing unit 130 can sense the folded state or the unfolded state of the display unit 120. The folding sensing unit 130 may sense the folded state or the unfolded state of the display unit 120 by measuring an angle between the display areas of the display unit 120. And, the folding sensing unit 130 may sense the folded state or the unfolded state of the display unit 120 by comparing orientations of the display areas with each other. In order to measure the orientations of the display areas, the folding sensing unit 120 may include an acceleration sensor and/or a gyro sensor. And, the folding sensing unit 130 may sense the folded state or the unfolded state of the display unit 120 based on a length of the display unit 120 or whether the display unit 120 is expanded or not.

And, the processor 110 can control the display unit 120 and the folding sensing unit 130. The processor 110 can execute processor-executable commands stored in a memory. The processor can be implemented with a single chip or a plurality of chips.

Moreover, although it is not depicted in FIG. 2, the display device 100 can include at least one selected from the group consisting of a memory, a communication unit and a power supply. And, the display device 100 can be supplied with power from external. It is apparent that those having ordinary skill in the technical field to which the present specification pertains know that the display device 100 can include any other different configurations except the aforementioned configuration.

FIG. 3 is a diagram for examples of a display device.

Although the display device is depicted as a foldable display in FIG. 1, the display device can include various form factors including the foldable display as depicted in FIG. 3. For instance, as depicted in FIG. 3 (a), the display device may correspond to an extendible display. Or, as depicted in FIG. 3 (b), the display device may correspond to a rollable display device. And, if the extendible display or the rollable display is not expanded, it may be determined as a folded state. If the extendible display or the rollable display is expanded, it may be determined as a unfolded state. And, as depicted in FIG. 3 (b), the display device may correspond to a flexible display. The flexible display can be folded in accordance with a random axis. And, each of display areas can be distinguished from each other on the basis of the random axis. And, the display device can include a touchable display.

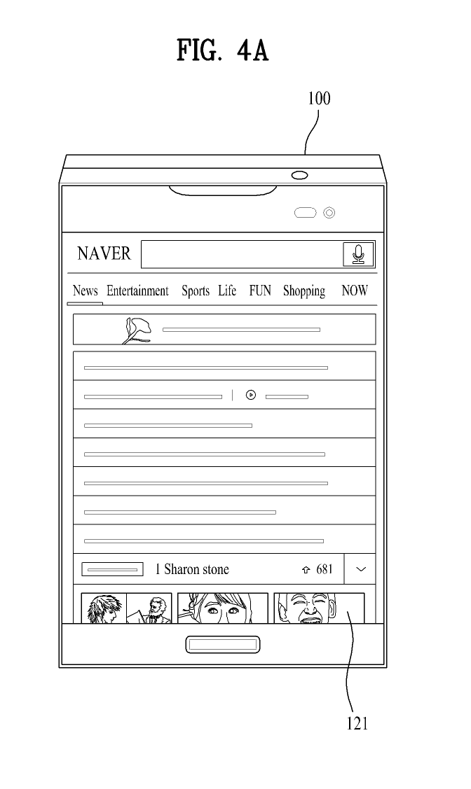

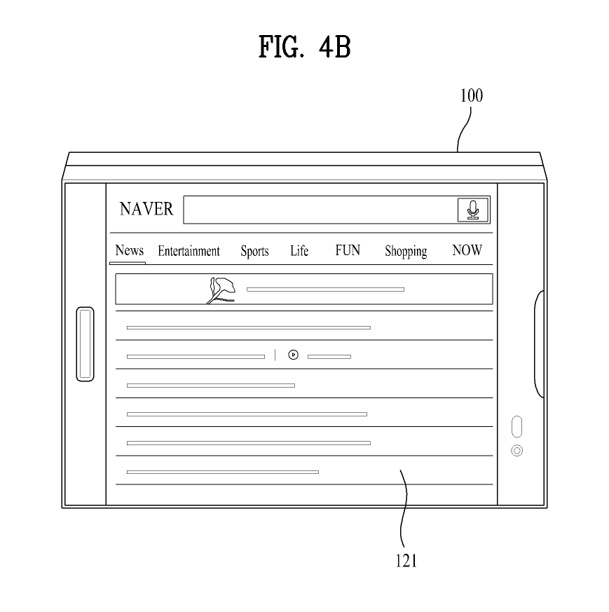

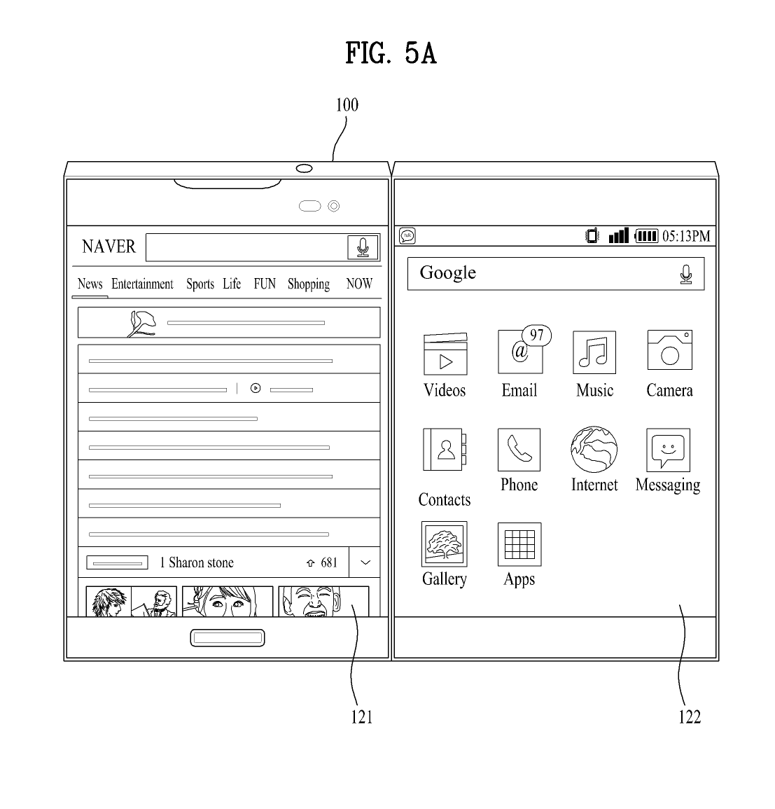

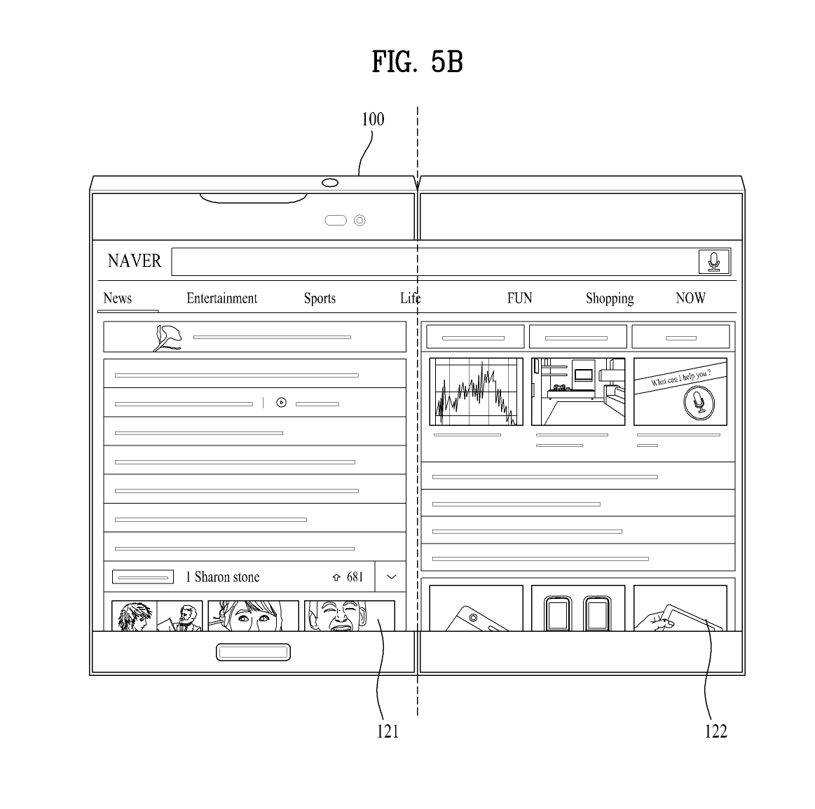

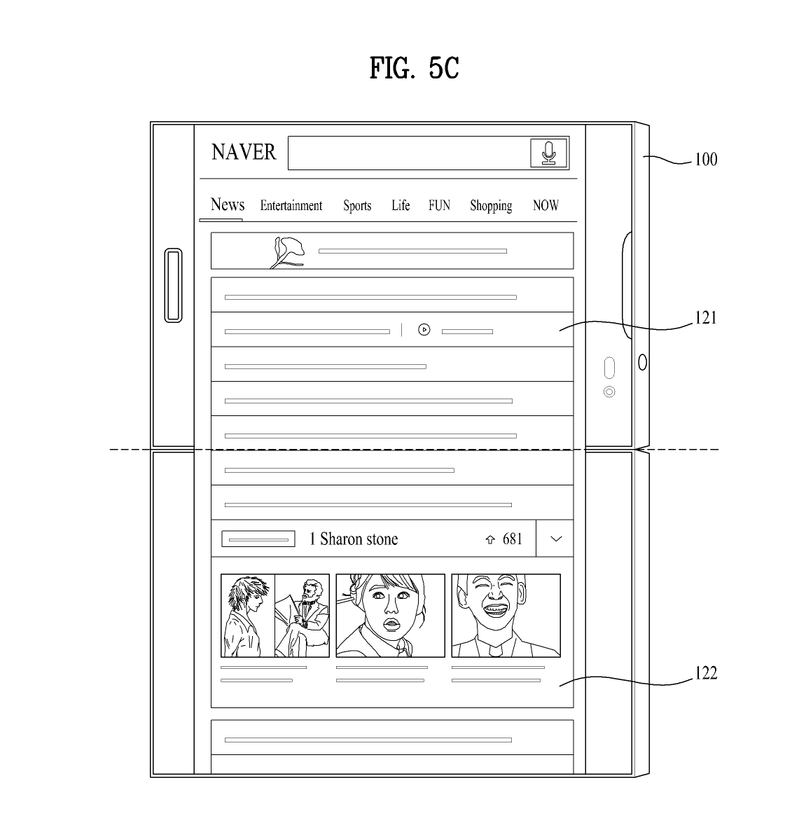

In the following, a display mode of the display device is explained with reference to FIG. 4a to FIG. 5c.

First of all, a landscape mode and a portrait mode are explained. The landscape mode means a display mode that a width of a display is greater than a height of the display. On the contrary, the portrait mode means a display mode that the height of the display is greater than the width of the display. In general, the landscape mode is suitable for a video application such as video playback and the portrait mode is suitable for a document editing application and the like. Recently, most of applications support both of portrait mode and the landscape mode.

FIG. 4a is a diagram for a folding-portrait display mode.

As depicted in FIG. 4a, the display device 100 is in a folded state. An internet application is allocated to a first display area 121. In a folding-portrait mode, a display mode of the first display area 121 corresponds to a portrait mode. A second display area (not depicted) may be in a standby state or a different application may be allocated to the second display area. In general, since a user uses a single display area when the display device is in the folded state, the first display area 121 can be used as a sole display area of display device 100. Yet, as mentioned in the foregoing description, a separate application is allocated to the second display area (not depicted) and the second display area can display the separate application.

FIG. 4b is a diagram for a folding-landscape display mode.

As depicted in FIG. 4b, the display device 100 is in a folded state. An internet application is allocated to a first display area 121. In a folding-landscape mode, a display mode of the first display area 121 corresponds to a landscape mode. As mentioned earlier with reference to FIG. 4a, a different application can be allocated to a second display area (not depicted) or no application can be allocated to the second display area.

FIG. 5a is a diagram showing that a first display area and a second display area display applications different from each other, respectively.

As depicted in FIG. 5a, an internet application may be allocated to a first display area 121 of the display device 100 and a home screen may be allocated to a second display area 122 of the display device 100. In particular, applications different from each other can be allocated to the first display area 121 and the second display area 122, respectively. Meanwhile, referring to FIG. 5a, the display mode respectively displayed in the first display area 121 and the second display area 122 corresponds to the portrait mode. Yet, the display mode respectively displayed in the first display area 121 and the second display area 122 may correspond to the landscape mode.

FIG. 5b is a diagram for an unfolding-landscape display mode.

Referring to FIG. 5b, a display unit 100 is in an unfolded state and one application is allocated to a first display area 121 and a second display area 122. In particular, the first display area 121 and the second display area 122 may operate as a single display area. When the first display area 121 and the second display area 122 are used as a single display area in the unfolding-landscape display mode, an allocated application is displayed with the landscape mode.

FIG. 5c is a diagram for an unfolding-portrait display mode.

Referring to FIG. 5c, a display unit 100 is in an unfolded state and one application is allocated to a first display area 121 and a second display area 122. In the unfolding-portrait display mode, one application is allocated to both the first display area 121 and the second display area 122. Yet, the allocated application is displayed with the portrait mode in the unfolding-portrait display mode.

Meanwhile, referring to FIG. 5b and 5c, a boundary line between the first display area 121 and the second display area 122 is indicated by a dotted line. Yet, if the display unit 100 is in an unfolded state, practically, the boundary line between the first display area 121 and the second display area 122 may not be seen.

In relation to FIG. 4a to FIG. 5c, a switching between the folding-landscape mode and the folding-portrait mode and a switching between the unfolding-landscape mode and the unfolding-portrait mode of the display device 100 may occur based on an orientation of the display device 100. And, a switching between the portrait mode and the landscape mode of each of the display areas 122/122 may occur based on the orientation of display. For instance, the orientation of the display device 100 may include an orientation of the display device 100 for a direction of gravity. And, the switching between the aforementioned display modes may occur based on an additional input.

Meanwhile, the aforementioned folding-landscape, the unfolding-landscape, the folding-portrait and the unfolding-portrait correspond to explanation of the display mode explained based on the display device 100. Yet, the display mode of each of the display areas 121/122 and the display mode of the display device 100 can be differently evaluated. For instance, referring to the unfolding-landscape mode depicted in FIG. 5b, each of the display modes of the first and the second display area 121/122 can be evaluated as a portrait mode. This is because each width of the first and the second display areas 121/122 is shorter than each height of the first and the second display areas 121/122. Similarly, referring to the unfolding-portrait mode depicted in FIG. 5c, each of the display modes of the first and the second display area 121/122 can be evaluated as a landscape mode.

In the foregoing description, the configuration and the display mode of the display device 100 have been explained with reference to FIG. 1 to FIG. 5c. In the following, a concrete method of controlling the display device 100 is explained. It is apparent that those having ordinary skill in the technical field to which the present specification pertains know that the method of controlling the display device 100 can be combined with the aforementioned configuration and the display mode of the display device 100.

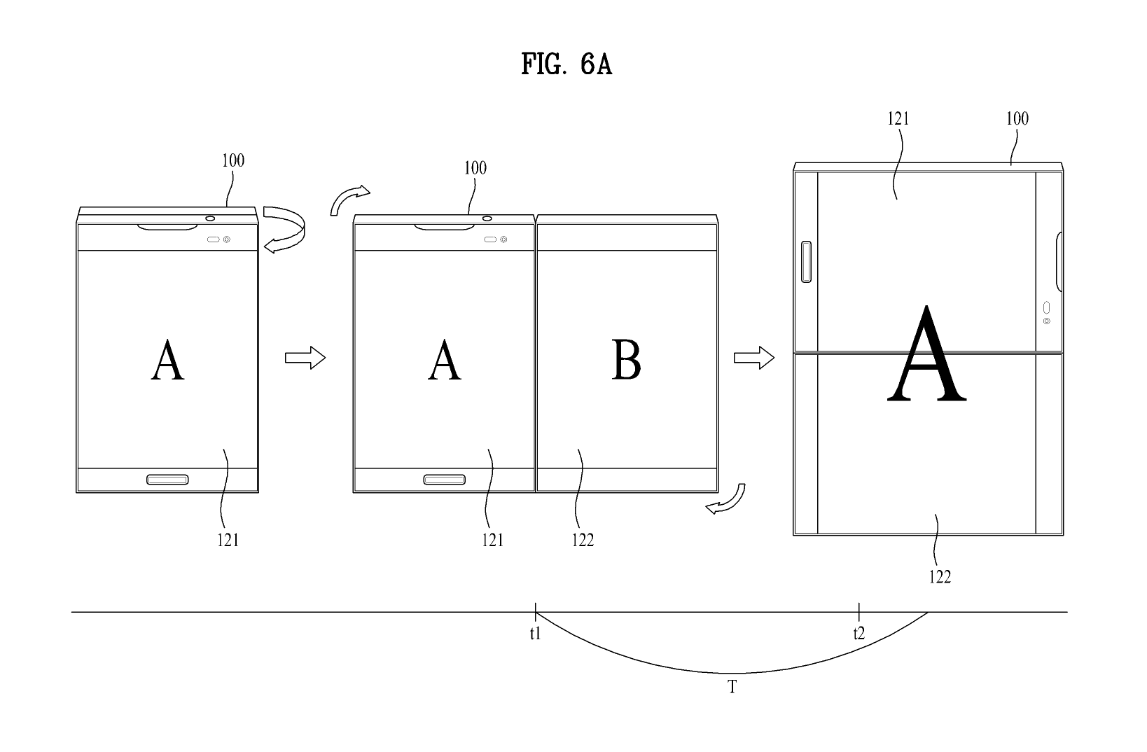

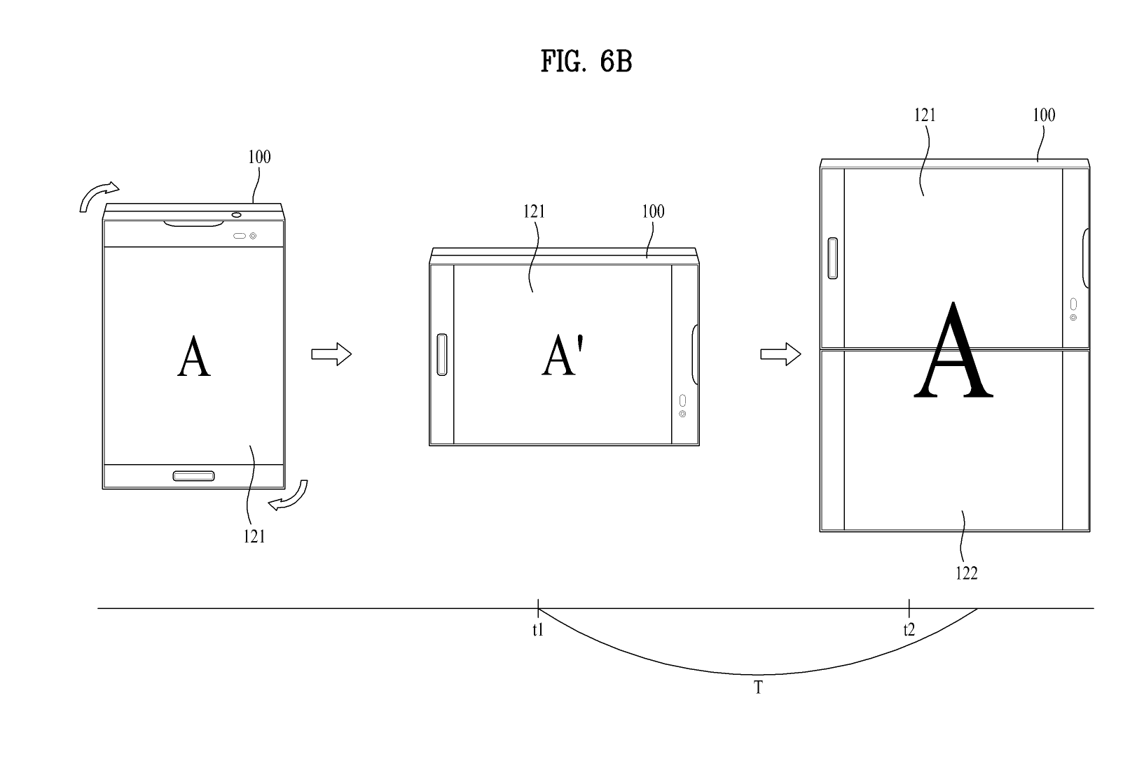

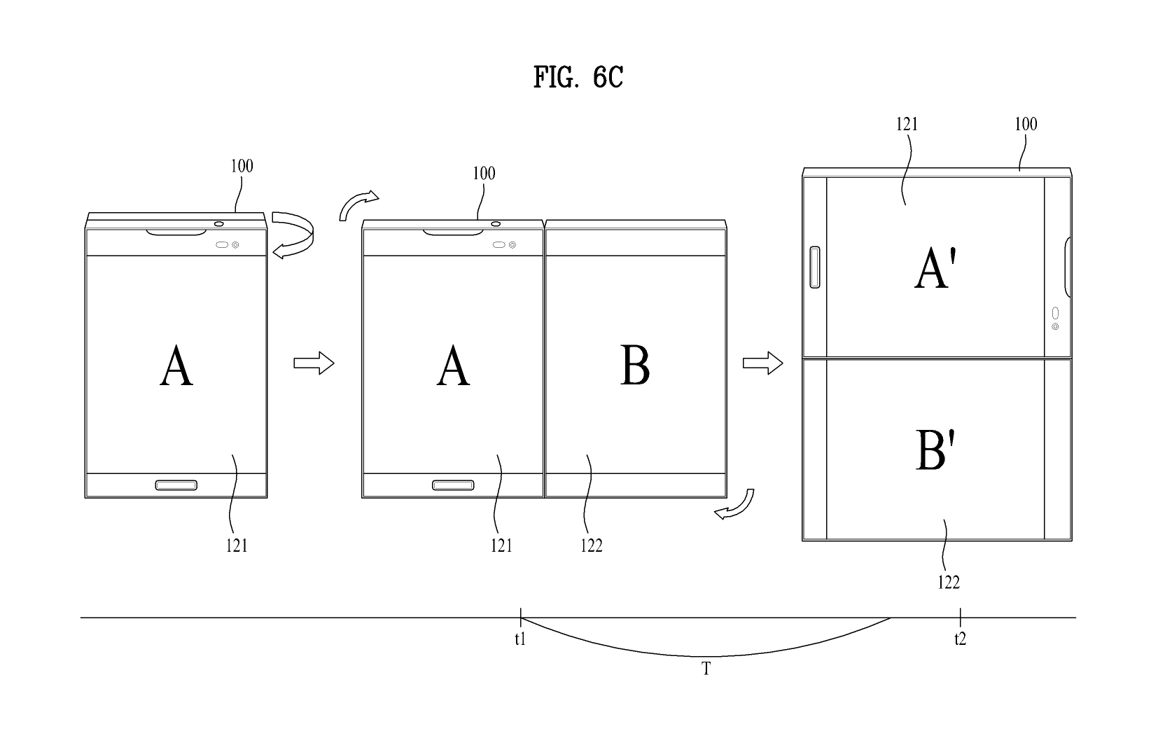

FIG. 6a is diagram for a switching of a display mode of a display device according to one embodiment of the present specification.

In FIG. 6a, the display device 100 rotates after the display device is unfolded. In an initial state, the display device 100 is in a folded state and an application A is allocated to a first display area 121. In the initial state, the application A is displayed with a unfolding-portrait mode.

On a time t1, the display device 100 is unfolded. Unfolding of the display device 100 can be defined as an event. On the time t1, an application B may be allocated to a second display area 122. Yet, no application may be allocated to the second display area 122. If the display device 100 is unfolded, the display device 100 may activate a display of the second display area 122.

On a time t2, a display mode of the first display area 121 of the display device 100 is switched to the landscape mode from the portrait mode. The switching of the display mode of the first display area 121 can be defined as a further different event. The switching of the display mode of the first display area 121 means a switching between the portrait mode and the landscape mode of the first display area 121. The switching is different from the switching (e.g., the folding-landscape, the folding-portrait, the unfolding-landscape and the unfolding-portrait) of the display mode of the display device 100. As depicted in FIG. 6a, the switching of the display mode of the first display area 121 may occur based on a rotation (i.e., change of orientation) of the display device 100. And, the switching of the display mode of the first display area 121 may occur based on a separate input.

If time interval between the time t1 (unfolding of the display device 100) and the time t2 (switching of the display mode of the first display area 121) is less than a predetermined time threshold T, the display device 100 displays the application A, which is allocated to the first display area 121, in the first display area 121 and the second display area 122 in a manner of expanding a display of the application. By doing so, the display mode of the display device 100 is switched to the unfolding-portrait mode.

Meanwhile, referring to FIG. 6a, the application A allocated to the first display area 121 is displayed in the first display area 121 and the second display area 122 in a manner of being expanded. Yet, the application B allocated to the second display area 122 can be displayed in the first display area 121 and the second display area 122 in a manner of being expanded.

For instance, if the display device 100 is unfolded on the time t1, the application B is displayed in the second display area 122. In this case, a user can determine which application is to be displayed in the first display area 121 and the second display area a manner of being expanded by differentiating a rotation direction of the display device 100. In particular, the user can determine to display the application A in the first display area 121 and the second display area 122 in a manner of expanding a display of the application A by placing the first display area 121 to which the application A is allocated on the top of the second display area 122. On the contrary, the user can determine to display the application B in the first display area 121 and the second display area 122 in a manner of expanding a display of the application B by placing the second display area 122 to which the application B is allocated on the top of the first display area 121. Hence, it may consider not only the time between the unfolding of the display device 100 and the switching of the display mode of the first display area 121 but also a relative position between the first display area 121 and the second display area 122.

FIG. 6b is diagram for a switching of a display mode of a display device according to a different embodiment of the present specification.

Referring to FIG. 6b, a display mode of the first display area 121 is switched on the time t1 and the display device 100 is unfolded on the time t2. In particular, an order of occurrence of each event is different from the order of occurrence of each event in FIG. 6a.

In an initial state, the display device 100 is in a folded state and an application A is allocated to a first display area 121. In the initial state, the application A is displayed with a unfolding-portrait mode.

On a time t1, a display mode of the first display area 121 of the display device 100 is switched to the landscape mode from the portrait mode (In this case, A′ means that the application A is displayed with the landscape mode). The switching of the display mode of the first display area 121 can be defined as an event. The switching of the display mode of the first display area 121 is identical to what is described earlier with reference to FIG. 6a.

On a time t2, the display device 100 is unfolded. Unfolding of the display device 100 can be defined as a further different event. On the time t2, an application different from the application A may be allocated to a second display area 122. Or, no application may be allocated to the second display area 122. If the display device 100 is unfolded, the display device 100 may activate a display of the second display area 122.

If time interval between the time t1 (switching of the display mode of the first display area 121) and the time t2 (unfolding of the display device 100) is less than a predetermined time threshold T, the display device 100 displays the application A, which is allocated to the first display area 121, in the first display area 121 and the second display area 122 in a manner of expanding a display of the application A. By doing so, the display mode of the display device 100 is switched to the unfolding-portrait mode.

FIG. 6c is diagram for a switching of a display mode of a display device according to one embodiment of the present specification.

Referring to FIG. 6c, the display device 100 is unfolded on a time t1 and the display mode of the first display area 121 is switched on the time t2. Yet, unlike what is mentioned earlier with reference to FIG. 6a, time interval between the time t1 and the time t2 is greater than the predetermined time threshold T in FIG. 6c. In this case, the display device 100 does not display the application A, which is allocated to the first display area 121, in the second display area 122 in a manner of expanding a display the application A. In particular, the display device 100 displays the application A allocated to the first display area 121 in the first display area 121 only with the landscape mode (In this case, A′ means that the application A is displayed with the landscape mode). And, the display device 100 displays the application B allocated to the second display area 122 in the second display area 122 only with the landscape mode (In this case, B′ means that the application B is displayed with the landscape mode).

Meanwhile, similar to the embodiment of FIG. 6b, the display mode of the first display area 121 can be switched on the time t1 and the display device 100 can be unfolded on the time t2. In this case, as mentioned earlier with reference to FIG. 6c, if the time interval between the time t1 and the time t2 is longer than the predetermined threshold T, the display device 100 does not display the application A allocated to the first display area 121 in the second display area 122 in a manner of expanding a display of the application A.

And, if the time interval between the unfolding of the display device 100 and the switching of the display mode of the first display area 121 is longer than the predetermined time threshold T, a user interface for triggering an application allocated to the first display area 121 to be displayed in the first display area 121 and the second display area 122 can be provided. The user interface may prompt a user whether to expand a display.

And, referring to FIGS. 6a to 6c, the initial state of the display device 100 corresponds to the folding-portrait mode. Yet, in case that the initial state of the display device 100 corresponds to the folding-landscape mode, the method of switching the display mode mentioned earlier with reference to FIG. 6a to FIG. 6c can be applied as well. For instance, when the initial state of the display device 100 corresponds to the folding-landscape mode, if the time interval between the time on which the display mode of the first display area 121 is switched and the time on which the display device 100 is unfolded is shorter than the predetermined time threshold, the display device 100 may display an application allocated to the first display area 121 in the first display area 121 and the second display area 122 in a manner of expanding a display of the application. In particular, the display device 100 displays the application allocated to the first display area 121 in the first display area 121 and the second display area 122 with the unfolding-landscape mode. And, as mentioned earlier with reference to FIG. 6c, if the time interval between the time on which the display mode of the first display area 121 is switched and the time on which the display device 100 is unfolded is longer than the predetermined time threshold, the display device 100 does not display the application allocated to the first display area 121 in the second display area in a manner of expanding a display of the application.

Hence, if the display device is unfolded and the display mode of the first display area 121 is switched within the predetermined time threshold, the display device 100 displays the application allocated to the first display area 121 in the first display area 121 and the second display area 122 in a manner of expanding the display of the application. In this case, if the initial state corresponds to the portrait mode, a final state corresponds to the unfolding-portrait mode. If the initial state corresponds to the landscape mode, the final state corresponds to the unfolding-landscape mode. Hence, a user can expand a screen while maintaining a display format of an application.

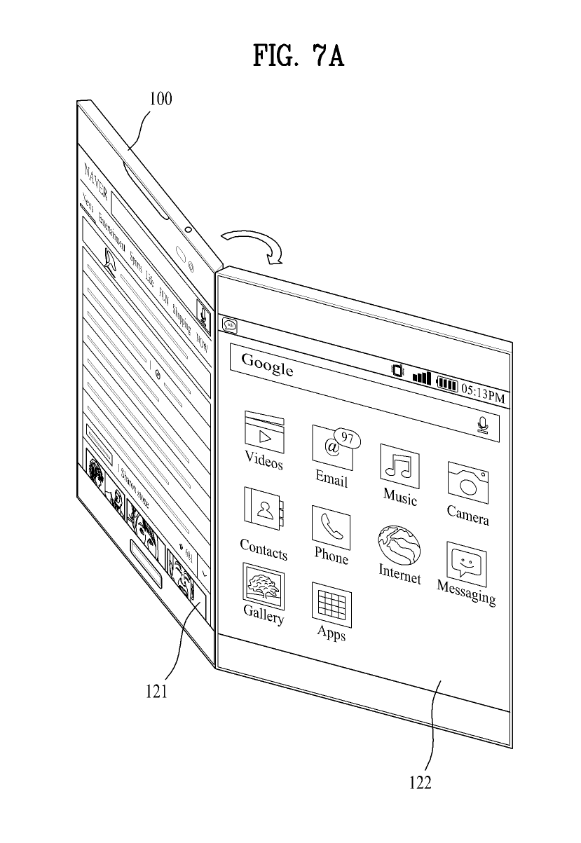

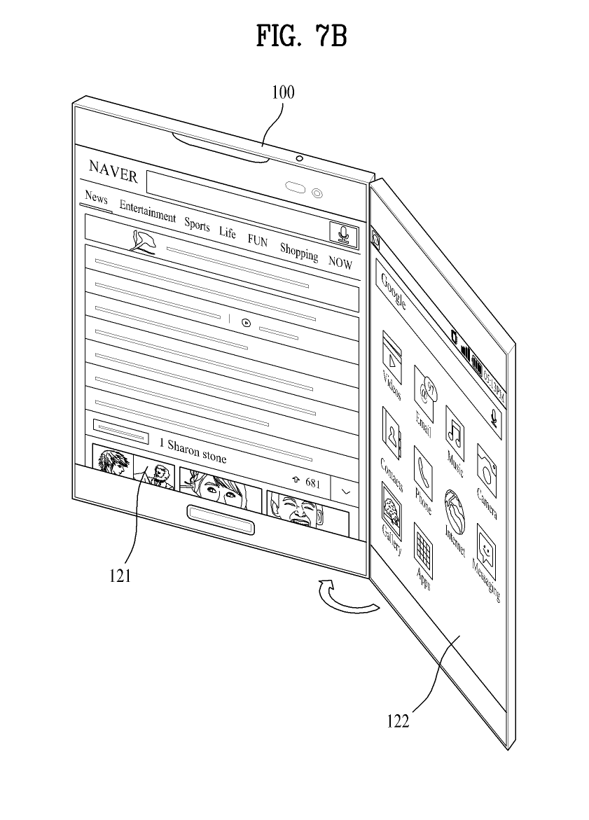

FIGS. 7a and 7b show a folding direction of the display device 100.

Referring to FIG. 7a, if the display device 100 is in a folded state, the first display area 121 and the second display area 122 are positioned at an external surface of the display device 100.

On the contrary, referring to FTC. 7b, if the display is in a folded state, the first display area 121 and the second display area 122 are positioned at an internal surface of the display device 100. In this case, the first display area 121 may correspond to a transparent display device. And, if the display device 100 is in the folded state, the second display area 122 may operate as a back-light of the first display area 121. Or, the second display area may display a separate application.

Hence, referring to FIG. 7a and FIG. 7b, the display device 100 includes at least one display area capable of being observed from external. In order to determine whether to display observed content or an application in a different display area in a manner of expanding a display of the content or the application, the methods mentioned earlier with reference to FIG. 6a to FIG. 6c can be used.

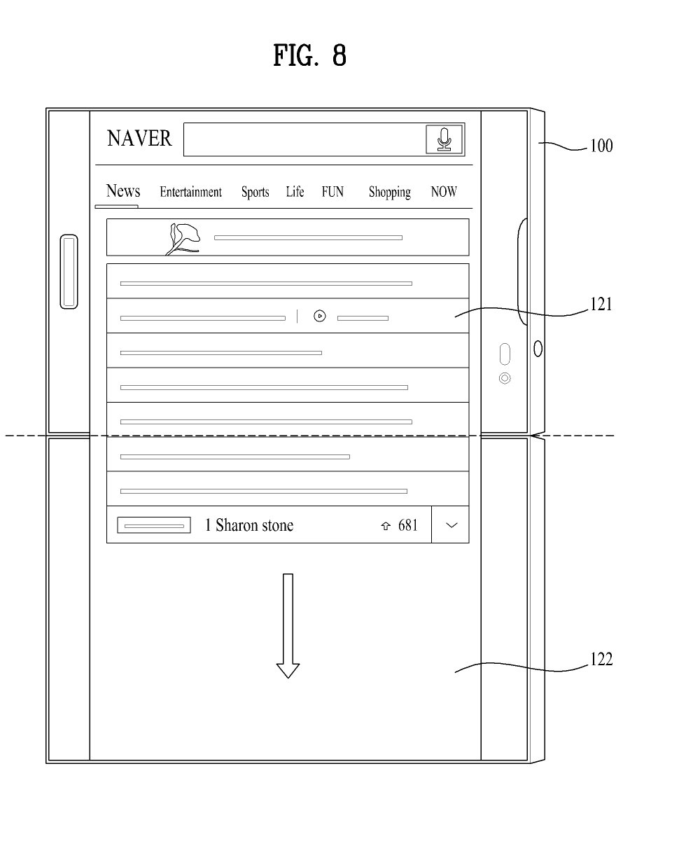

FIG. 8 is a diagram for expansion of a display according to a switching of a display mode.

Referring to FIG. 8, an application allocated to the first display area 121 is gradually expanding to the second display area 122. In particular, as mentioned earlier with reference to FIG. 6a and FIG. 6b, if the display device 100 is unfolded and the display mode of the first display area 121 is switched within a predetermined time threshold, the display device 100 firstly displays an application, which is to be displayed in a manner of being expanded, in the first display area 121 with the switched mode and may be then able to display the application in the second display area 122 in a manner of gradually expanding a display of the application. In particular, the display device 100 can provide visual feedback based on the application, which is to be displayed in a manner of being expanded. And, as depicted in FIG. 8, although the display of the application is gradually expanding from the top to the bottom, if the display mode of the display device 100 is switched to the unfolding-landscape mode, the display of the application can be gradually expanding from the left of the display device 100 to the right.

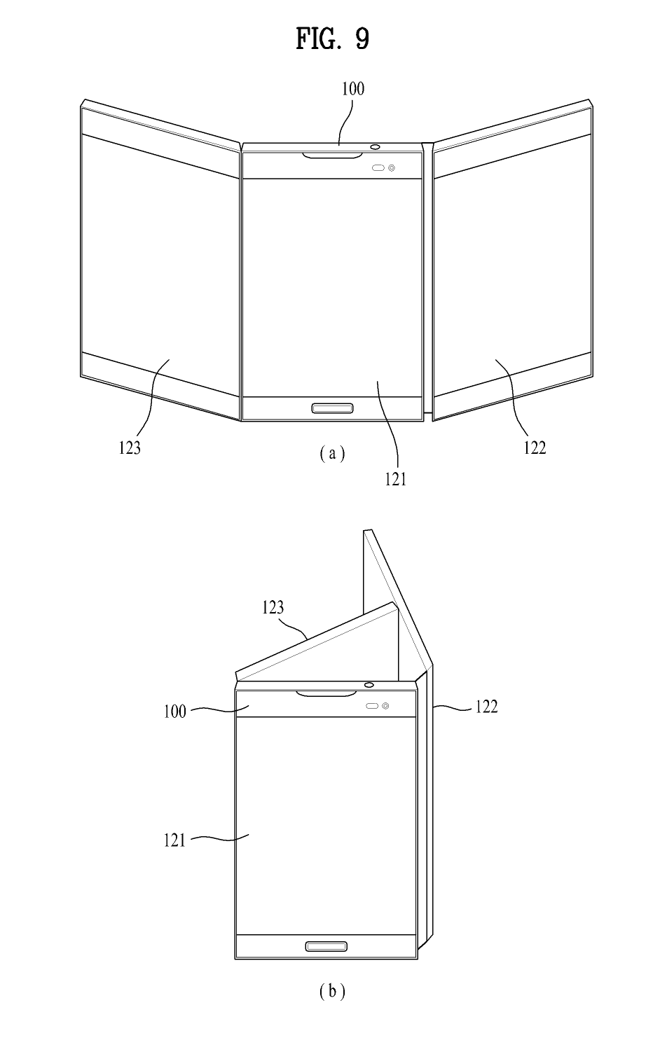

FIG. 9 is a diagram for a display device including three display areas.

Referring to FIG. 9, the display device 100 includes a first display area 121, a second display area 122 connected with a right side of the first display area 121 and a third display area 123 connected with a left side of the first display area 121. Although FIG. 9 (b) shows that the second display area 122 is positioned at an external surface of the display device 100 when the display device 100 is completely folded, the third display area 123 can be positioned at the external surface of the display device 100.

The display device 100 shown in FIG. 9 has operations similar to the operations of the display device 100 mentioned earlier with reference to FIG. 5a to FIG. 8. For instance, if the second display area 122 or the third display area 123 is unfolded and the display mode of the first display area is switched within a predetermined time threshold, an application allocated to the first display area 121 is displayed in the first display area 121 and an unfolded display area (122 or 123) in a manner of being expanded. And, if time interval between time of unfolding the second display area 122 or the third display area 123 and time of switching the display mode of the first display area 121 is longer than a predetermined time threshold, the display device 100 displays the application allocated to the first display area in the first display area with the switched display mode and does not display the application allocated to the first display area in the unfolded display area (122 or 123) in a manner of expanding the display of the application.

And, if the second display area 122 and the third display area 123 are unfolded and the display mode of the first display area 121 is switched within the predetermined threshold, the display device 100 can display the application allocated to the first display area 121 in the second display area 122 and the third display area 123 in a manner of expanding the display of the application.

Hence, since the operations of the display device 100 depicted in FIG. 9 are similar to the operations of the display device mentioned earlier with reference to FIG. 5a to FIG. 8, for clarity, duplicated explanation is omitted at this time.

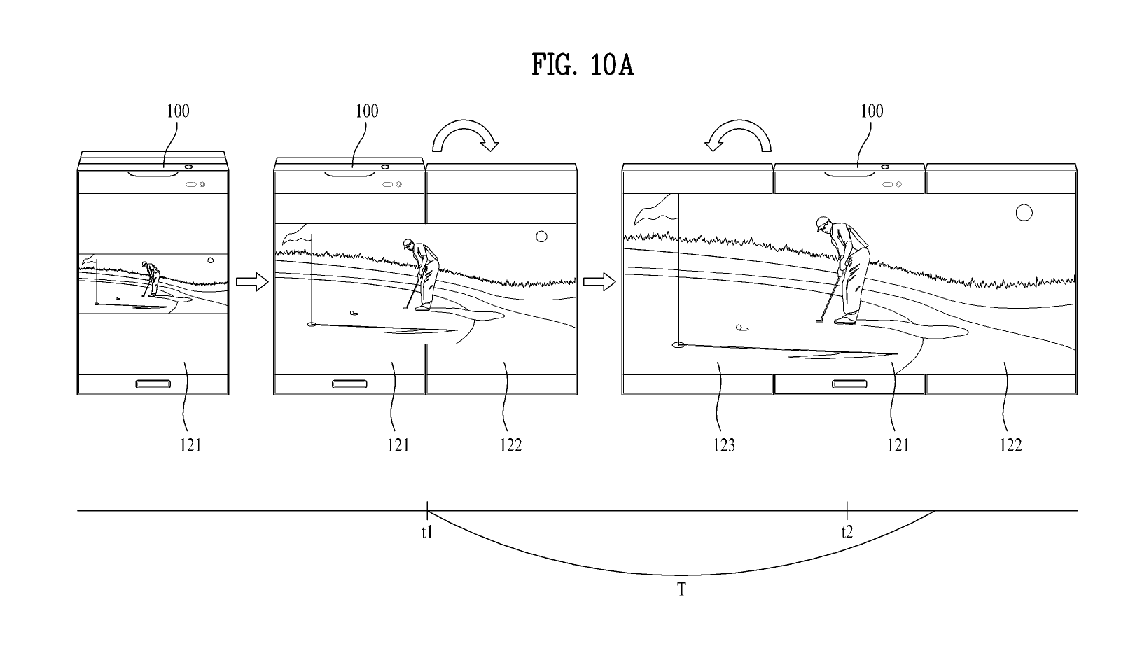

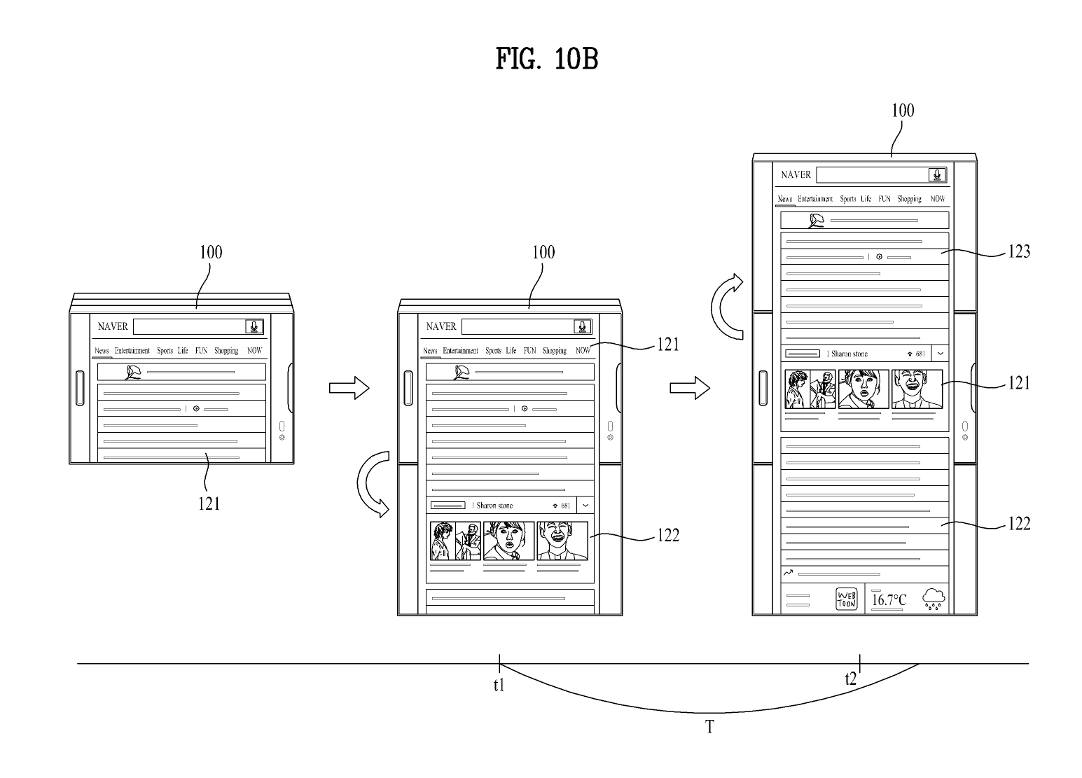

FIG. 10a and FIG. 10b are diagrams for expansion of a display according to one embodiment of the present specification.

Referring to FIG. 10a, the second display area 122 and the third display area 123 are sequentially unfolded within a predetermined time threshold T. The second display area 122 is unfolded on time t1 and then the third display area 123 is unfolded on time t2. In this case, a user may want to execute an application different from an application allocated to the first display area 121 in the third display area 123. On the contrary, the user may want to display the application allocated to the first display area 121 in a manner of expanding display of the application up to the third display area 123. Hence, whether to display an application in a manner of expanding the display of the application is determined on the basis of the predetermined time threshold T.

As depicted in FIG. 10a, in an initial state, the first display area 121 operates in the portrait mode. The third display area 123 is unfolded within the predetermined time threshold T from the time t1 on which the second display area 122 is unfolded. In this case, the display device 100 displays an application allocated to the first display area 121 in the first display area 121, the second display area 122 and the third display area 123 with the landscape mode in a manner of expanding a display of the application. On the contrary, if the third display area 123 is unfolded after the predetermined time threshold T from the time t1 on which the second display area 122 is unfolded, a different application can be allocated to the third display area 123.

As depicted in FIG. 10b, in an initial state, the first display area 121 operates in the landscape mode. The third display area 123 is unfolded within the predetermined time threshold T from the time t1 on which the second display area 122 is unfolded. In this case, the display device 100 displays an application allocated to the first display area 121 in the first display area 121, the second display area 122 and the third display area 123 with the portrait mode in a manner of expanding a display of the application. On the contrary, if the third display area 123 is unfolded after the predetermined time threshold T from the time t1 on which the second display area 122 is unfolded, a different application can be allocated to the third display area 123.

The configuration and the operation of the display device mentioned earlier with reference to FIG. 9 to FIG. 10b can be combined with the aforementioned embodiments mentioned earlier with reference to FIG. 6a to FIG. 8.

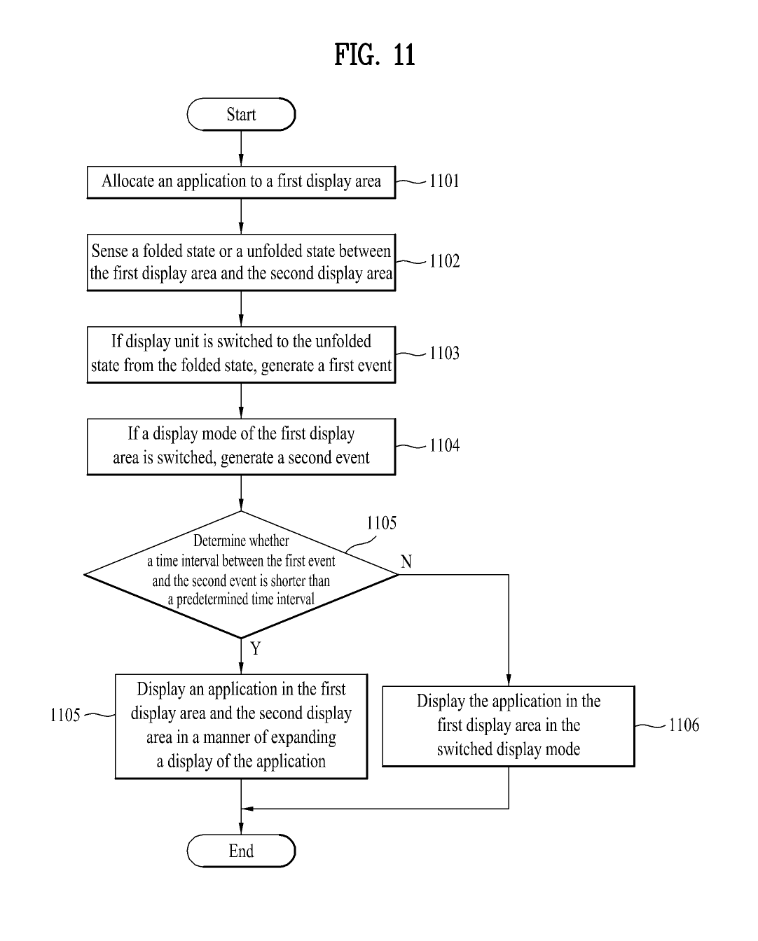

FIG. 11 is a flowchart for a controlling method of a display device according to one embodiment of the present specification.

The display device can include configuration and type of the display device mentioned earlier with reference to FIG. 1 to FIG. 5c and FIG. 9. Hence, the display device includes two or more display areas and can include various form factors.

An application is allocated to a first display area of the display device [S1101]. The allocated application includes the internet, a home screen, and random applications. The display device senses a folded state or an unfolded state between the first display area and a second display area [S1102]. If a display unit is switched to the unfolded state from the folded state, the display device generates a first event [S1103]. And, if a display mode of the first display area is switched, the display device generates a second event [S1104]. As mentioned earlier with reference to FIG. 6a to FIG. 6c, although the first event may occur first, the second event may also occur first.

The display device determines whether time interval between the first event and the second event is shorter than a predetermined time interval [S1105]. If the time interval is shorter than the predetermined time interval, the display device displays an application allocated to the first display area in the first display area and the second display area in a manner of expanding a display of the application [S1105]. On the contrary, if the time interval is longer than the predetermined time interval, the display device does not display the application allocated to the first display area in the second display area in a manner of expanding the display of the application. In particular, the display device displays the application allocated to the first display area in the first display area with a switched display mode [S1106].

And, a method of controlling the aforementioned display device can be combined with the various embodiments mentioned earlier with reference to FIG, 6a to FIG. 8 and can be applied to the display device mentioned earlier with reference to FIGS. 10a and 10b.

The predetermined time threshold of the present specification may correspond to a predefined value or a value inputted by a user.

A digital device according to the present specification and a method of controlling therefor may not limitedly apply to the composition and method of the aforementioned embodiments. The aforementioned embodiments may be configured in a manner of being selectively combined the whole of the embodiments or a part of the embodiments to achieve various modifications.

Meanwhile, a display device according to the present specification and a method of controlling therefor can be implemented with a software readable by a processor in a recording media readable by the processor, which is equipped in the display device. The recording media readable by the processor may include all kinds of recording devices for storing data capable of being read by the processor. The examples of the recording media readable by the processor may include a ROM, a RAM, a CD-ROM, a magnetic tape, a floppy disc, an optical data storing device and the like, The recording media readable by the processor are distributed to the computer systems connected by a network and codes readable by the processor can be stored and executed in a manner of being distributed.

While the present specification has been described and illustrated herein with reference to the preferred embodiments and diagrams thereof the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

What is claimed is:

1. A display device, comprising:
a display unit comprising at least a first display area and a second display area, the second display area connected with the first display area;
a folding sensing unit configured to sense a folded state or an unfolded state between the first display area and the second display area; and
a processor configured to control the display unit and the folding sensing unit,
wherein the processor is further configured to:
allocate an application to the first display area,
if the display unit is switched to the unfolded state from the folded state, generate a first event,
if a display mode of the first display area is switched to a landscape mode from a portrait mode or is switched to the portrait mode from the landscape mode, generate a second event,
if a time interval between the first event and the second event is shorter than a predetermined time threshold, display the application in the first display area and the second display area in a manner of expanding a display of the application, and
if the time interval is longer than the predetermined time threshold, display the application in the first display area in a switched display mode.

2. The display device of claim 1, wherein the processor is further configured to:
if the display mode of the first display area is switched to the landscape mode from the portrait mode and the time interval is shorter than the time threshold, display the application in the second display area in an unfolding-landscape mode in a manner of expanding the display of the application in the second display area, wherein the unfolding-landscape mode allocates the application to the first display area and the second display area and wherein the display mode of each of the first and the second display area corresponds to the landscape mode.

3. The display device of claim 1, wherein the processor is further configured to:
if the display mode of the first display area is switched to the portrait mode from the landscape mode and the time interval is shorter than the time threshold, display the application in the second display area in an unfolding-landscape mode in a manner of expanding the display of the application in the second display area, wherein the unfolding-portrait mode allocates the application to the first display area and the second display area and wherein the display mode of each of the first and the second display area corresponds to the portrait mode.

4. The display device of claim 1, wherein when the display unit is in the folded state, the first display area and the second display area are positioned at an external surface of the display device.

5. The display device of claim 1, wherein when the display unit is in the folded state, the second display area is positioned at an internal surface of the display device and wherein the first display area corresponds to a transparent display area.

6. The display device of claim I, wherein the processor is further configured to:
switch at least one display mode of the first display area and the second display area to the landscape mode from the portrait mode or to the portrait mode from the landscape mode based on an orientation of the display device.

7. The display device of claim 6, wherein the processor is further configured to:
if the display mode of the first display area is switched to the landscape mode from the portrait mode, generate the second event, and
if the second event is generated after a time of generating the first event, the time interval between the first event and the second event is shorter than the time threshold and the first display area is positioned at the top of the second display area, display the application in the first display area and the second display area in a manner of expanding the display of the application.

8. The display device of claim 7, wherein the processor is further configured to:
display the application in the first display area in the landscape mode in response to the second event, and
display the application displayed in the landscape mode in the second display area in a manner of gradually expanding the display of the application displayed in the landscape mode.

9. The display device of claim 1, wherein the processor is further configured to:
if the time interval is longer than the time threshold, provide a user interface triggering the application to be displayed in the first display area and the second display area in a manner of expanding the display of the application.

10. The display device of claim 1, wherein the processor is further configured to, if the first event is generated, activate a display of the second display area.

11. The display device of claim 10, wherein the processor is further configured to, if the first event is generated, allocate the application or a predetermined application to the second display area.

12. The display device of claim 1, wherein the display unit comprises at least one selected from the group consisting of a flexible display, a foldable display, an extendible display, a touchable display and a rollable display.

13. The display device of claim 1, wherein the folding sensing unit is further configured to sense the folded state or the unfolded state of the display unit by measuring an angle between the first display area and the second display area.

14. The display device of claim 1, wherein the folding sensing unit is further configured to sense the folded state or the unfolded state of the display unit by comparing an orientation of the first display area with an orientation of the second display area.

15. A display device, comprising:
a display unit comprising a first display area, a second display area connected with a right side of the first display area and a third display area connected with a left side of the first display area;
a folding sensing unit configured to sense a folded state or an unfolded state between the first display area and the second display area and between the first display area and the third display area; and
a processor configured to control the display unit and the folding sensing unit,
wherein the processor is further configured to:
allocate an application to the first display area,
if the second display area is switched to the unfolded state from the folded state, generate a first event,
if the third display area is switched to the unfolded state from the folded state, generate a second event,
if a display mode of the first display area is switched to a landscape mode from a portrait mode or is switched to the portrait mode from the landscape mode, generate a third event,
if a first time interval between the first event and the third event is shorter than a first time threshold, display the application in the first display area and the second display area in a manner of expanding a display of the application,
if the first time interval is longer than the first time threshold, display the application in the first display area in a switched display mode.

16. The display device of claim 15, wherein the processor is further configured to:
if a second time interval between the second event and the third event is shorter than the first time threshold, display the application in the first display area and the third display area in a manner of expanding the display of the application and
if the second time interval is longer than the first time threshold, display the application in the first display area in the switched display triode.

17. The display device of claim 15, wherein the processor is further configured to, if the first event, the second event and the third event are generated within a predetermined second time threshold, display the application in the first display area, the second display area and the third display area in a manner of expanding the display of the application.

18. The display device of claim 15, wherein the processor is further configured to, if the first event and the second event are generated while the application is displayed in the first display area in the portrait mode and a third time interval between the first event and the second event is shorter than a predetermined third time threshold, display the application in the second display area and the third display area in the landscape mode in a manner of expanding the display of the application.

19. The display device of claim 15, wherein the processor is further configured to, if the first event and the second event are generated while the application is displayed in the first display area in the landscape mode and a third time interval between the first event and the second event is shorter than a predetermined third time threshold, display the application in the second display area and the third display area in the portrait mode in a manner of expanding the display of the application.

20. A method of controlling a display device comprising a display unit comprising at least a first display area and a second display area, comprising the steps of:
allocating an application to the first display area;
sensing a folded state or an unfolded state between the first display area and the second display area;
if the display unit is switched to the unfolded state from the folded state, generating a first event;
if a display mode of the first display area is switched to a landscape mode from a portrait mode or is switched to the portrait mode from the landscape mode, generating a second event;
if a time interval between the first event and the second event is shorter than a predetermined time threshold, displaying the application in the first display area and the second display area in a manner of expanding a display of the application; and
if the time interval is longer than the time threshold, displaying the application in the first display area in a switched display mode.
